(19) United States
(12) Patent Application Publication
(10) Pub. No.: US 2015/0326714 A1
(43) Pub. Date: Nov. 12, 2015

(54) Method and System for Obtaining Prospective Client Information

(71) Applicants: Ian James Roncoroni, Phillipsburg, NJ (US); Gianni Martire, Englewood Cliffs, NJ (US)

(72) Inventors: Ian James Roncoroni, Phillipsburg, NJ (US); Gianni Martire, Englewood Cliffs, NJ (US)

(21) Appl. No.: 14/275,708

(22) Filed: May 12, 2014

(51) Int. Cl. H04M 3/42; H04M 7/00; H04M 3/523; H04M 3/51

(52) U.S. Cl. CPC H04M 3/42059; H04M 3/5191; H04M 7/0027; H04M 3/5235

(57) ABSTRACT

A method and system is provided for providing an incentive for a customer to provide additional information regarding demographic and purchasing habits. Such information is then used to create a customer profile which can be used to enhance the customer experience as well as to determine rates of customer acquisition and retention.

### CROSS REFERENCE TO RELATED APPLICATIONS

This application claims benefit of U.S. Provisional Patent Application No. 61/843,774 filed on Jul. 8, 2013. This application further claims benefit as a continuation-in-part of U.S. patent application Ser. No. 14/246,598 filed Apr. 7, 2014 which is a continuation-in-part application of U.S. patent application Ser. No. 14/070,059 filed on Nov. 1, 2013, which claims priority to U.S. Provisional Patent Application No. 61/724,100, filed on Nov. 2, 2012, and to U.S. Provisional Patent Application No. 61/722,005, filed on Nov. 2, 2012, the entire disclosures of which are incorporated herein by reference.

### TECHNICAL FIELD

This technology relates to systems, devices, and methods for gathering customer information. Specifically, this technology relates to methods and systems for incentivizing customers to provide information.

### BACKGROUND

Companies are always looking for more effective ways to obtain and retain consumers as well as target their marketing to the most appropriate segments of the market. Customer acquisition and customer retention are two metrics used to determine the return on investment of efforts to monetize consumer relationships. Effective acquisition increases the number of leads/prospects captured, increases retail traffic and increases sales. Part of designing an effective acquisition campaign is acquiring knowledge about potential customers. While there are databases of consumer information, the information is frequently outdated or inaccurate. Additionally advertisement placement is frequently based on speculative data making it difficult to target a marketing campaign to a likely market segment.

Consumers' attention spans are fleeting and their time is precious. Today's consumers have no time for sales people who do not know what they want or companies who repeatedly ask them to provide the same information. Consumers want the entire purchasing experience to be pleasant and one of the biggest frustrations is having to speak to multiple agents and repeat the same data over and over again.

Currently, when people transact business remotely, they are forced to deal with a cumbersome process of reciting information for the agent to hear. This may cause miscommunication and opens up the customer to potentially fraudulent attacks as the customer repeats confidential information on a recorded line to multiple people. In most cases, placing a telephone call conveys only the user's telephone number and, sometimes, their name. All remaining information (including profile information and billing information) must be provided orally—dictated to the called party or agent each time and frequently multiple times. Information obtained in such a fashion provides little information to a business about the customer or ways to retain the customer. Additionally, there is no reason for a customer to provide any feedback. There is therefore a need for businesses to rapidly obtain better information about callers and their needs and to encourage a consumer to provide such information.

### BRIEF DESCRIPTION OF THE FIGURES

FIG. 1 is an example of a centralized caller profile system.

FIG. 2 is an example of means of storing and amending customer profiles.

FIG. 3 is an embodiment of a method of prioritizing calls.

FIG. 4 is an embodiment of a method of prioritizing calls.

FIG. 5 is an embodiment of a lead generation system.

### DETAILED DESCRIPTION

Provided herein is a means for a consumer to easily provide information to a third party such as a business and for the business or other third party to reward such behavior. The business or third party may obtain consumer information by any means generally used. In some embodiments, the business or third party recipient of the information may offer an incentive to the provider of the information, such as priority service, discounts, rewards points, free shipping, merchandise, gift cards, and the like. Consumers must actively opt in to providing information in order to obtain the rewards offered. Information provided by the consumer may be gathered by any means generally used including via electronic mail, web pages, pop ups, text messages, or any other means of electronic communication.

The system described herein may utilize any web page or mobile page generally used by consumers to contact a business or other third party. For example, the request for information or offer of an incentive may appear on a customer service page, on an order page, on a landing page, in a banner, next to a search box, next to contact information, on an order confirmation page, with a shopping cart, or on any other useful part of a website. In some embodiments, the system described herein may include a “button” on a webpage which can be clicked or accessed in another way by any visitor of the site, webpage, or other multimedia outlet. This button could have a logo or text advertising its function, or a statement of the incentive provided to the consumer by the business or other third party. (For example, the button could say “skip the hold line,” indicating that by entering information into the fields provided, the user will benefit from skipping the hold line of the customer service center he/she is contacting.) Upon clicking this on-screen button or other device, the customer will be provided access to a set of fields for data entry. These fields may appear as part of a pop-up, in a separate window, in the same window, or some other place which may or not be affiliated with the retail site. The set of fields may be for any set of information the business or third party is interested in obtaining including, but not limited to, name, email address, home address, telephone number, employment, preferred language, buying preferences, age, hobbies, social media presence and the like. In some embodiments, a field for information acquisition may include a particular department within the business or they type of information being sought by the consumer. Similarly, billing information such as name, address, and other information required to complete a sales transaction may be requested. In one embodiment, billing information includes information chosen from credit card number, credit card verification code, checking account, bank routing number, credit rating, and the like. In some embodiments, the same information may be collected at a brick and mortar location. The set of fields for information may be maintained by the retailer or by a third party hosting company. The third party hosting company may be any business that collects and stores customer information for one or more retailers.

The information acquired from the consumer may be transmitted electronically, via the internet, via phone, or any other means of communication to the retailer. In other embodiments, the information acquired from the consumer may be sent to a third party hosting the fields. In some embodiments, the information collected may be stored by the retailer and/or a third party hosting company, creating a detailed profile of a consumer interested in the products and/or services provided by a particular business or other third party.

A consumer contacting the company, either at the time of entering the information, or at a later date, may be identified by the profile that has been created. When the user eventually contacts the business, either via phone, in person, or over the Internet, the business will already have or have access to a personal profile of that user. This allows the business to greet the user, providing a more personal experience and preventing the user from becoming frustrated at having to repeat the same information repeatedly.

In return for providing the information requested by the set of fields, the business or other third party may provide an incentive to the customer. Such incentives may include, but are not limited to, priority in the call line, a special number or VIP status, coupons, discounts, reward points, sweepstake entry, gift cards, merchandise, and the like.

When a customer contacts or is contacted by the business or other third party, a centralized caller profile system identifies the customer and provides profile information and billing information about the customer to the agent receiving or making the call. The centralized caller profile and payment system provides a method of automatically identifying a caller and intelligently transferring that caller to an appropriate call designation or agent.

The centralized caller profile system identifies customers in a centralized caller database. The centralized caller database may be any type of database used by one of skill in the art. In some embodiments, the customer information may be stored on a remote server owned by the business or third party hosting company. In other embodiments, the customer database may be cloud based with the information stored by a third party. In some embodiments, the information in a customer profile may be created and revised by the user, as needed, using a network terminal, such as a computer-based internet browsing system, or an interactive voice response system. The updates are registered and stored in the database, and can be sent at the users' discretion to third parties.

The system and methods disclosed herein provide a caller profile system and service that enable businesses and other third parties to rapidly identify a caller via a centralized caller profile database. Businesses and third parties are able to access caller associated content (e.g., the caller's profile information) using the caller's Unique Identifier, which can be a telephone number, email address, or other identifier unique to the Caller. In some embodiments, a unique identifier may be generated by an application on a device owned by the Caller each time the Caller connects with the Business or Third party. This profile can be used by third parties in any way that is helpful to that party and its business, or in any way the information is important to the relationship between the user and the party. The system uses the caller's Unique Identifier to catalog the information for a given caller. When the caller contacts a called party, the system uses the phone number or other identifier to identify the caller, query the database, and send profile information to the called party and/or the agent. A caller profile may contain any type of content, including text, image, or other form of multimedia content. The profiles are maintained by the users who created them to establish the profiles that are delivered to called parties with the delivery of each call, and/or at the request of the user. By accessing the customer profiled, the way the agent knows all about the caller when answering the call.

In some embodiments, the system and method of described herein may add a personal identification number (PIN) component or other key identifier to the system. Such PIN may be a word, a phrase, letters, numbers, symbols or any combination thereof. When a caller contacts a called party, the agent verifies the caller's PIN with the system's record for that caller on the cloud database. If the PINs match (i.e., the caller's PIN is verified), then the system releases the caller's information.

The agent may see all or part of the customer's profile information as required. For example, in some embodiments, the agent may be prevented from seeing the customer's billing information, but the billing information may be authorized to make a purchase. Although both are “content,” personal information is different from billing information.

Automatically identifying the Caller and providing the service provider with information about the Caller adds value to the user by making the exchange of personal data over the phone faster and more efficient. The Caller no longer has to verbally exchange this information, and risk miscommunication with the answering agent. Businesses also save time and money by having up to date customer information which reduces errors in shipping, billing, etc. The third party hosting company benefits by saving valuable agent time in gathering customer information.

The party requesting the information may provide an incentive to the caller to provide the information prior to the call. Such incentives may include, but are not limited to, priority in the call line, a special number or VIP status, coupons, discounts, reward points, sweepstake entry, gift cards, merchandise, and the like. In one embodiment, the system may advance the caller's place in a queue. In one embodiment, the system may route the caller to a senior, superior, or more experienced agent. In another embodiment, the system routes the call to an agent sharing a commonality with the selected agent, such as an agent having a particular same zip code, name, or other distinguishing feature. In some embodiments, the caller may be identified as high priority which may signal a call center to bump the call with the high priority mark ahead of the other callers on the call queue.

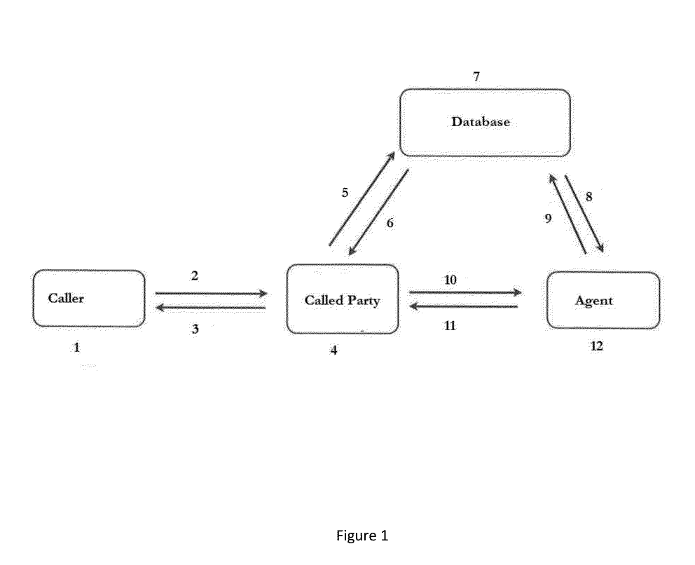

For example, in some embodiments, the system described herein provides a Centralized Caller Profile system (100) as shown in FIG. 1 which efficiently authenticates and identifies callers and provides a caller profile to an Agent. The centralized caller profile system comprises a Caller (1), a Called party (4), a Database (7) and an Agent (12). The system 100 of the claimed invention achieves this efficiency by using a database (7), such as a cloud database that houses, utilizes, and distributes profile information to agents (12) and third parties that have permission to access the information. The profiles contained in the database (7) are created, modified, maintained, and distributed by the caller (1) or by the agent (12) or other third party at the request of the caller (1). A “caller” (1) can be a calling party, that is, the party placing or initiating a call, especially a telephone call, to a called party (4). A “called party” (4) can be any party receiving a call from a caller.

In some embodiments, the database (7) is maintained by a third party hosting company that hosts the set of fields collecting information prior to the call. In other embodiments, the database (7) is maintained by the party being called (4). The database (7) may obtain customer information by any means generally used. In some information, the data in the database (7) is acquired by telephone, text, internet input, manually entered, wirelessly such as through Bluetooth or a similar protocol or any other means of communication. The called party (4) can be an agent or another intelligent entity with whom a caller can interact or converse, e.g., about particular goods or services. In some examples, the intelligent entity is an intelligent entity answering the telephone call and engaging the caller (1) in conversation. In another embodiment, the agent (12) is a human customer service representative. In a further embodiment, the agent (12) includes a person answering telephone calls within the customer service department of a business. In additional embodiments, the agent (12) can be a non-human entity, such as an interactive voice response (“IVR”) system.

At any point during the call, if the caller (1) wishes to make a payment or otherwise release protected information, the caller (1) may provide a PIN to the called party (4) or to the agent (12). If the PIN matches the security code saved in the caller's profile, the database (7) sends that information electronically to the agent (12). In a case where the agent's computer is linked to the database (7), the information would be sent directly to the agent's computer. As used herein, a “PIN” is a personal identification number or code. The term PIN is often redundantly used within the context of “PIN number,” which should be considered synonymous with PIN. Traditionally the term “PIN” means a numeric passcode (i.e., a number) shared between a user and a system that can be used to authenticate the user to the system. PIN can include any personal identification code consisting of numbers, letters, words, or combinations thereof.

The arrows in FIG. 1 show the interconnectivity of these entities by representing the transfer (i.e., transmission) and/or retrieval (i.e., acquire or receive) of profile information, including user data through real-time connectivity and telephone connections. A “telephone connection” can be a live connection between two or more parties, where at least one party is connected via a telephone. For example, a telephone conversation between two participant would include a telephone connection, through which the participants converse. In at least one example, the live telephone connections between two or more parties include the real-time exchange of verbal or other information via the telephone connection.

As shown in the centralized caller profile system 100 of FIG. 1, a caller (1) can transmit information to the called party (4) along communication line (2) to establish a telephone connection. Likewise, the called party (4) can transmit information to the caller (1) along communication line (3) so that the caller retrieves information. Typically one party is sending information while the other party is retrieving information. “Transmitting” include causing data or a signal to pass on from one location or person to another. It can also include broadcasting or sending out, such as an electrical signal, a digital signal, an audio signal, or radio signal.

In one embodiment, transmitting includes sending a unique identifier to a database (7) via an Internet connection. For example, a called party (4) can look up the profile for an incoming caller (1), by transmitting the incoming telephone number information to the database (7) along communication line (5). Retrieving can include actively requesting or accepting available information from a party to a particular connection. For example, during a telephone call, the called party may use known methods (e.g., Caller ID) of retrieving the telephone number of caller. The database (7) may then transmit profile information to the called party (4) along communication line (6). In some embodiments, the database (7) may transmit profile information and other information to the agent (12) along communication line (8). If the caller (1) reveals additional information that should be included in their profile during a call, the information may be transmitted by the agent (12) along communication line (9) to update the caller (1) profile in database (7). Such additional information may include, but is not limited to, revised content that differs from a previous version stored and associated with a particular record. For example, caller (1) may update, edit, and revise some or all of their bibliographic information, address, billing information, customer preferences, and the like.

In some embodiments, the called party (4) may transmit profile information directly to the agent (12) using communication line (10), without accessing or transmitting data to or from the database (7). Similarly, the Agent (12) can transmit updated and other profile information directly to the called party (4) along communication line (11).

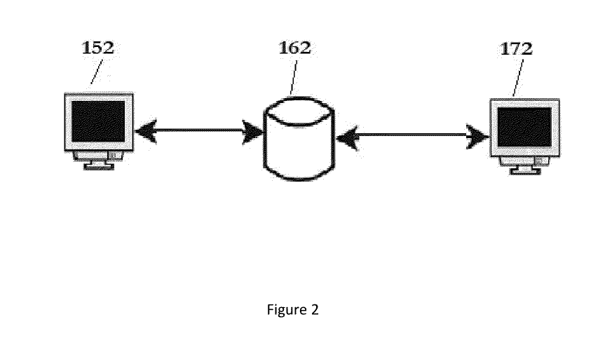

As shown in FIG. 2, in some embodiments the caller profile is stored in a Universal Database (162). Such a database may associate the content associated with a customer in one or more different ways including by name, telephone number, address, zip code, purchasing habits, email address, age, gender, income and the like. A “caller profile” means a particular representation of personal information associated with a particular person or entity. In some embodiments, a Caller profile comprises the name, address, telephone number, and email address for a particular person. Customers (152) may update their profiles online such as through a set of fields or by telephone. In some embodiments, the customers may access their complete profiles. In other embodiments, they may not access their complete profiles, but they may add or change them. For example, in some embodiments, when a set of fields is completed online, there may be a check box asking if any of the information has changed. In other embodiments, a customer may be asked to verify certain information. In a further embodiment, a customer may relay information to an agent (172) who may update the customer's profile. In yet another embodiment, a customer profile may be updated automatically when a transaction such as a purchase occurs. In some embodiments, the caller profile information or billing information may be stored in a caller profile database operated by a service provider and/or may be stored in a corporate or user operated database. As shown in FIG. 2, the caller profile information is stored in the universal database 162. Regardless of the manner in which the content is stored, the content can be created and revised by the user, as needed, using a network terminal, such as an internet browser, or an interactive voice response system. Updates and revisions are registered and stored in the caller profile database (contact database 162) and can be sent at the users' discretion to third parties, including agents 172 and other third parties.

The database used to store caller profiles may be maintained by the called party or by an outside system. The system and methods disclosed herein provide a caller profile system and service that enable third parties the ability to rapidly identify a caller via a centralized caller profile database. A caller profile may contain any type of content, including text, image, or other form of multimedia content. The profiles are maintained by the user who created them to establish the profiles that are delivered to called parties with the delivery of each call, and/or at the request of the user. The content (e.g., caller profile information) may be stored in a Caller Profile Database operated by a service provider, but may also be stored in a corporate or use operated Caller Profile database. However stored, the content may be created and revised by the user, as needed, using a network terminal, such as a computer-based internet browsing system, or an interactive voice response system. The updates are registered and stored in the database, and can be sent at the users' discretion to third parties. Third parties are able to access caller associated content (e.g., the caller′ profile information) using the caller's Unique Identifier, which can be a telephone number, email address, or other identifier unique to the Caller. This profile can be used by third parties in any way that is helpful to that party and its business, or in any way the information is important to the relationship between the user and the party.

Automatically identifying the Caller and providing the service provider with information about the Caller adds value to the user by making the exchange of personal data over the phone faster and more efficient. The Caller no longer has to verbally exchange this information, and risk miscommunication with the answering agent. The third party accessing this information benefits from the disclosed system and methods by saving valuable agent time in gathering this necessary information. Normally, their businesses also save time and money by having up to date customer information which reduces errors in shipping, billing, etc.

In one sense, the centralized caller profile system for authenticating and identifying callers is an efficiency mechanism that simplifies and expedites the exchange of personal information from users to third parties. The system achieves this efficiency by using a Cloud Database, e.g., housing, utilizing, and distributing profile information contained in a database to any third party having permission. As used herein, the term “Cloud Database” means a database that typically runs on a cloud computing platform. The term “cloud computing” describes a variety of computing concepts that involve a large number of computers connected through a real time communication network such as the Internet. In one sense, cloud computing is a synonym for distributed computing over a network and means the ability to run a program on many connected computers at the same time. The term cloud computing is also commonly used to refer to network-based services which appear to be provided by real server hardware, which in fact are served up by virtual hardware, simulated by software running on one or more real machines. Such virtual servers do not physically exist and can therefore be moved around and scaled up (or down) on the fly without affecting the end user. Examples of popular cloud computing platforms include Amazon EC2, GoGri and Rackspace, which can be utilized by those having ordinary skill in the art. There are two common deployment models: users can run databases on the cloud independently, using a virtual machine image, or they can purchase access to a database service, maintained by a cloud database provider. Of the databases available on the cloud, some are SQL-based and some use a NoSQL data model.

Conventional caller queues employ first-in-first-out (“FIFO”) waiting lines for callers. In such FIFO waiting lines, the waiting callers are serviced in the order that the call is received. “Preferential positioning” refers to placing a Caller in a Caller Queue ahead of other callers who may have entered the Caller Queue earlier in time. For example, the Caller may be bumped or pushed ahead in the Caller Queue based on the Caller's priority status.

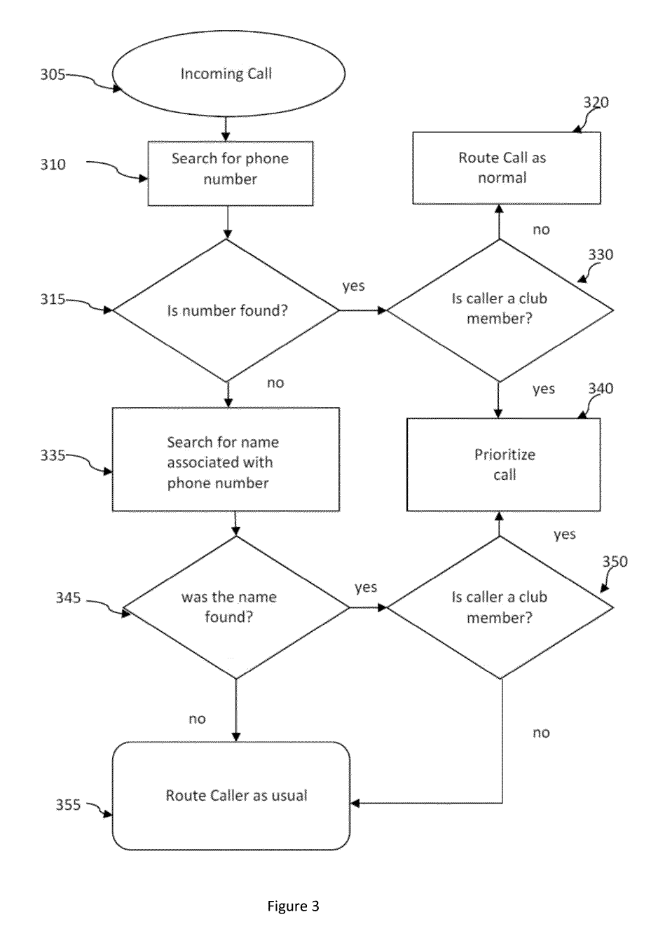

A caller may receive priority status in a variety of ways. In some embodiments, such as shown in FIG. 3, callers who are members of a particular loyalty club may be given priority status for their calls, regardless of the reason for their calls. An incoming call (305) may trigger a search for the originating phone number (310). If a number is found (315), the caller profile is searched to determine if the caller is a loyalty club member (330). If the caller is a loyalty club member the call is prioritized (340). If the number is not found, the customer profile associated with the name attached to the number via caller identification is used to search the database (335). If the name is found, the caller profile is searched to determine if the caller is a loyalty club member (35). If the caller is a loyalty club member then the call is prioritized (340). If the caller is not a loyalty club member then the call is routed as usual (320 and 335).

In some embodiments, the caller may be asked to enter a unique identifier either by typing on a keyboard, giving the number verbally, or otherwise transmitting the identifier. The unique identifier is then transmitted to a database. In some embodiments, the database then identifies the caller profile associated with the unique identifier and transmits the information to an agent. In other embodiments, the database identifies the caller profile associated with the unique identifier and may move the caller to a different part of the queue depending on the information in the caller profile. In some embodiments, the preferential positioning comprises placing the caller in the caller queue at a higher priority than the last position in the Caller Queue at the time of the transfer. For a high status Caller, the preferential positioning results in less time waiting in a caller line, a faster connection.

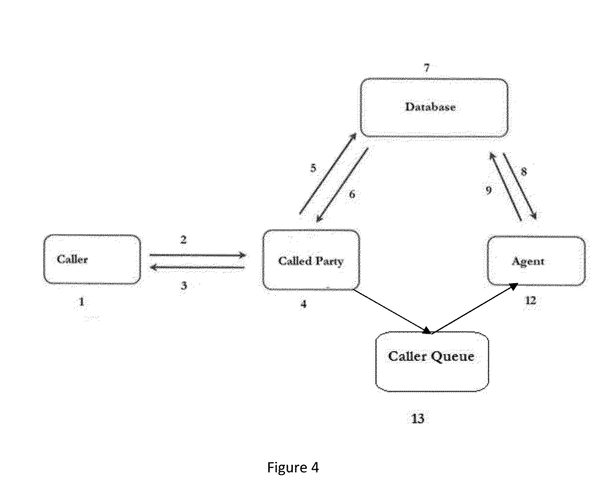

In other embodiments, as shown in FIG. 4, a caller may be given priority based on the information in their profile. As shown in FIG. 4, caller (1) contacts a called party (4). The called party (4) requests that the caller (1) transmit a unique identifier. The called party (4) then sends the unique identifier to the database (7). Based on the information in the caller profile associated with the unique identifier, the called party (4) may preferentially position the caller (1) in the caller queue (13). In one embodiment, the method of prioritizing a telephone call comprises preferentially positioning the Caller at the front 50% of the Caller Queue. The term “front 50%” means closer in line to the Agent than 50% of the other Callers in the Caller Queue. In one embodiment, the method of prioritizing a telephone call comprises preferentially positioning the Caller at the front 75% of the Caller Queue. The term “front 75%” means closer in line to the Agent than 75% of the other Callers in the Caller Queue.

In another embodiment, the caller (1) may be sent to a different agent or group of agents based on the information associated with the caller profile. For example, if the caller speaks a particular language, the customer may be routed to an agent who speaks that language. In another embodiment, there may be an agent or agent(s) dedicated to callers (1) who make a certain number of purchases a year, spend a particular amount, are members of a loyalty club, and the like. If the caller profile in the database (7) contains information indicating that specific routing should be chosen, the caller (1) may be routed to the queue of the specific agent or agent assigned to respond to calls from that type of caller (1).

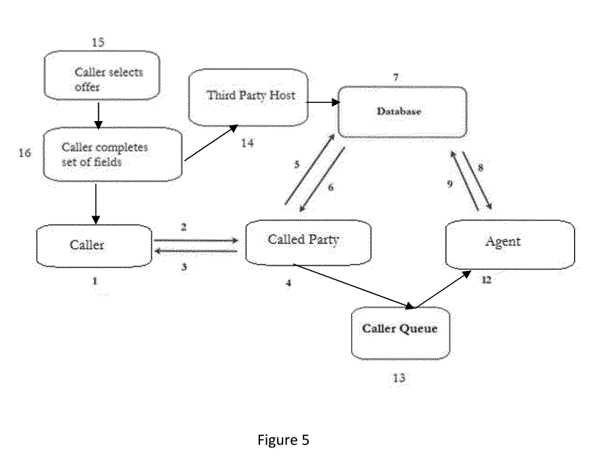

As shown in FIG. 5, a lead generation system is used to obtain and retain information on individuals who are interested or are using products and services sold or offered by a called party. The lead generation system comprises a caller (1), a called party (4), a third party (14), a database (7), the offer chosen by the caller (15), a set of fields to be completed (16) and a communication connection between the caller and the called party, the called party and a database, the set of fields and the third party, and a third party and a database.

A third party (14) hosts a set of fields on the website of a called party (4). The set of fields may be located anywhere desired on the website of the called party (4). In some embodiments they are on a customer service page, on an order page, on a landing page, in a banner, next to a search box, next to contact information, on an order confirmation page, with a shopping cart, or any other useful part of the website. In some embodiments, the set of fields may be revealed in response to selection of an offer or other incentive to the customer. Such an offer or incentive may be present as text or graphics. For example, the customer may be offered priority service, discounts, rewards points, free shipping, merchandise, gift cards, and the like in return for providing information. Once the caller (1) selects the offer (15), the caller (1) is asked to complete all or part of the displayed fields (16) hosted by the third party (14). The third party then transmits the information along with a unique identifier which may or may not be chosen by the customer to a database (7). A caller (1) contacts a called party (4) using a communication line (2). The communication line (2) may be a telephone line, an internet connection, a wireless connection, a cellular connection and the like. The called party (4) identifies the caller by any means generally used. In some embodiments, once the caller (1) completes the set of fields (16), they may be offered a direct connection with the party to be called (4), i.e. a means to “click-to-call” or otherwise contact the called party (4). In other embodiments, the caller (1) may be request a call from the called party (4).

The called party (4) then identifies the caller (1). In some embodiments, the called party (4) requests a unique identifier from the caller (1). In other embodiments, the telephone number or set of fields is associated with the caller (1) when the caller completes the set of fields and clicks-to-call. In further embodiments, the caller (1) provides a telephone number where they can be reached. Upon receiving the identifying information, the called party (4) transmits the identified information to a database (7). The database (7) transmits Content related to the caller (1) to the called party (4). The Content may be name, email address, home address, telephone number, employment, billing information, billing address, preferred language, buying preferences, age, hobbies, social media presence and the like. In some embodiments, the Content is sent to an Agent (12) who responds to the Caller (1).

The incentive to complete the set of fields may be provided in myriad ways. In some embodiments it may be provided to the caller's account. In other embodiments, it may be in the form of a gift card sent to the customer with the purchase. In additional embodiments, the customer may be given priority status when they contact the called party. For example, an Agent (12) may have a Caller Queue (13) comprising Callers (1) waiting to speak or otherwise communicate with the Agent (12). The Caller (1) contacts the Called Party (4). The Called Party (4) contacts the Database (7) to obtain information regarding the Caller (1). The Called Party (4) transfers the Caller (1) to the Caller Queue for the Agent and places the Caller (1) at a position in the queue (13) reflective of the information received from the Database (7). In some embodiments, the Caller (1) receives preferential positioning in the Caller Queue. Such preferential positioning may comprise placing the Caller (1) at a higher priority than the last position in the Caller Queue at the time of transfer.

The called party (4) may provide different incentives for different market segments, or may provide different incentives based on customer profiles. In other embodiments, the field set may merely request that the caller (1) pre-identify themselves in order to receive expedited service. Such identification may comprise one or more pieces of information that comprise a customer profile. In additional embodiments, the caller (1) may pre-identify the category of reason for calling or the department of interest in order to be directed to the appropriate agent.

While several embodiments of a system for rewarding customers for sharing information have been shown and described, it will be apparent to those skilled in the art that various modifications may be made without departing from the spirit of the method and system described herein.

We claim:

1. A Lead Generation System comprising:
a Caller;
a Called Party;
a Third Party;
a Cloud Database;
a telephone connection between the Caller and the Called Party;
the Called Party retrieving a Unique Identifier from the Caller;
the Called Party transmitting the Unique Identifier to the Cloud Database;
the Third Party transmitting Content to the Cloud Database; and
the Cloud Database transmitting Content to the Called Party.

2. The Lead Generation System of claim 1, comprising the Caller transmitting Content to the Third Party.

3. The Lead Generation System of claim 2, wherein the Content is chosen from personal information and billing information.

4. The Lead Generation System of claim 3, wherein transmitting Content to the Third Party comprises entering the Content into a form.

5. The Lead Generation System of claim 4, wherein the form is hosted by the Third Party and the said form is revealed to the Caller when the Caller clicks a button on a webpage hosted by the Third Party.

6. The Lead Generation System of claim 1, comprising an Agent.

7. The Lead Generation System of claim 6, comprising transmitting analog data from the Agent to the Caller and transmitting analog data from the Caller to the Agent.

8. The Lead Generation System of claim 6, comprising transmitting Content from the Cloud Database to the Agent.

9. The Lead Generation System of claim 4, comprising: an Agent; a Caller Queue for the Agent; a transfer of the Caller from the Called Party to the Caller Queue for the Agent; and a preferential positioning of the Caller in the Caller Queue.

10. The Lead Generation System of claim 9, wherein the preferential positioning comprises placing the Caller in the Caller Queue at a higher priority than the last position in the Caller Queue at the time of the transfer.

11. A method of providing a Caller Profile to an Agent, comprising: acquiring profile information from a Third Party;
establishing a telephone connection between a Called Party and a Caller;
acquiring a Unique Identifier from the Caller;
transmitting the Unique Identifier to a Cloud Based Database;
querying the Cloud Based Database for a record corresponding to the Unique Identifier;
identifying Content associated with the Unique Identifier;
transmitting the Content associated with the Unique Identifier to the Called Party.

12. The method of claim 11, comprising transmitting information from the Caller to the Third Party.

13. The method of claim 12, comprising transmitting information from the Caller to the Third Party by providing the Caller with a fillable online form.

14. The method of claim 13, comprising revealing the said fillable online form to the Caller by prompting the Caller to click on text or graphics hosted by the Third Party.

15. The method of claim 11, comprising establishing a telephone connection between the Caller and the Agent.

16. The method of claim 11, comprising acquiring the telephone number of the Caller.

17. The method of claim 14, comprising transmitting the telephone number of the Caller to the Cloud Database.

18. The method of claim 15, comprising querying the Cloud Based Database for a record corresponding to the telephone number of the Caller.

19. The method of claim 11, comprising transmitting analog data from the Caller to the Agent.

20. The method of claim 11, comprising transmitting analog data from the Agent to the Caller.
